(19) United States
(12) Patent Application Publication
(10) Pub. No.: US 2014/0045501 A1
(43) Pub. Date: Feb. 13, 2014

(54) MANIFOLD NETWORK WIRELESS COMMUNICATION SYSTEM

(71) Applicants: Benjamin Cheung, Berkeley Heights, NJ (US); Gopal N. Kumar, Bridgewater, NJ (US)

(72) Inventors: Benjamin Cheung, Berkeley Heights, NJ (US); Gopal N. Kumar, Bridgewater, NJ (US)

(21) Appl. No.: 13/569,313

(22) Filed: Aug. 8, 2012

(51) Int. Cl. H04W 36/18; H04W 36/36

(52) U.S. Cl. 455/437; 455/439

(57) ABSTRACT

Embodiments of the claimed subject matter provide a manifold network for a wireless communication system. One embodiment of the wireless communication system includes a plurality of base stations and one or more radio network controllers communicatively coupled to the base stations. The base stations can be configured to provide wireless connectivity within a geographic area such that user equipment in the geographic area maintain a substantially continuous call connection with at least two of the plurality of base stations. The radio network controller can be configured to select an active set of base stations from the plurality of base stations for the user equipment. The radio network controller can also be configured to select a configurable number of the plurality of base stations from the active set to maintain the substantially continuous call connection with the user equipment. The configurable number is at least two.

### BACKGROUND

This application relates generally to communication systems, and, more particularly, to wireless communication systems.

Wireless communication systems typically deploy numerous base stations (or other types of wireless access points) for providing wireless connectivity to mobile units (or other types of user equipment). Each base station is responsible for providing wireless connectivity to the mobile units located in a particular cell or sector served by the base station. Typically a mobile unit initiates wireless communication with one base station, e.g., when the user of the mobile unit would like to initiate a voice or data call. Alternatively, the network may initiate the wireless communication link with the mobile unit. For example, in conventional hierarchical wireless communications, a server transmits voice and/or data destined for a target mobile unit to a central element such as such as a Radio Network Controller (RNC). The RNC may then transmit paging messages to the target mobile unit via one or more base stations. The target mobile unit may establish a wireless link to one or more of the base stations in response to receiving the page from the wireless communication system. A radio resource management function within the RNC receives the voice and/or data and coordinates the radio and time resources used by the set of base stations to transmit the information to the target mobile unit.

User equipment may communicate with more than one base station in some circumstances. For example, a mobile unit may communicate with multiple base stations when the mobile unit is in the process of handing off between base stations in the network, e.g., during a make-before-break handover. Make-before break handovers include soft handovers and “softer” handovers. During a soft handover, a mobile unit is concurrently connected to two or more cell sectors associated with one or more base stations. The soft handover may be referred to as a “softer” handover when the cell sectors involved in the handoff are associated with a single base station. The same bit stream is received over the uplink via each of the cell sectors that are actively supporting a call in soft handover. The associated base station(s) can therefore send copies of the bit stream back to the RNC, which may examine the quality of the bit streams and select the bit stream with the highest quality.

Handoff of the mobile unit may be triggered by variations in the uplink or downlink signal strength caused by fading of the signal. For example, the strength of a downlink signal received at a mobile unit from a base station or an uplink signal transmitted from the mobile units to the base station can vary or “fade” in response to changes in the position or velocity of the mobile unit, changes in environmental conditions, and the like. There are three main types of fading: slow fading (or shadow) fading. fast (or Rayleigh) fading, and Doppler fading. Slow fading occurs when the line of sight between the mobile unit and the base station is blocked or obscured by an obstruction such as a man-made structure or a geographical feature such as a mountain. Fast fading occurs when the signals transmitted over the air interface reflect off of various structures in the environment of the mobile unit and the base station. Fast fading causes the transmitted signals to traverse multiple paths between the source and the receiver so that the transmitted signal is received multiple times. Different instances of the received signal may then be out of phase with each other so that they interfere constructively or destructively at the receiver. Doppler fading causes the frequency of the transmitted signal to increase as the mobile unit approaches the base station and to decrease as the mobile unit travels away from the base station.

### SUMMARY OF EMBODIMENTS

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a manifold network wireless communication system is provided. One embodiment of the wireless communication system includes a plurality of base stations and one or more radio network controllers communicatively coupled to the base stations. The base stations can be configured to provide wireless connectivity within a geographic area such that user equipment in the geographic area maintain a substantially continuous call connection with at least two of the plurality of base stations. The radio network controller can be configured to select an active set of base stations from the plurality of base stations for the user equipment. The radio network controller can also be configured to select a configurable number of the plurality of base stations from the active set to maintain the substantially continuous call connection with the user equipment. The configurable number is at least two.

In another embodiment, user equipment that may be used in a manifold network wireless communication system is provided. One embodiment of the user equipment can be configured to maintain substantially continuous call connections with a configurable number of base stations throughout a geographic area served by a plurality of base stations. The configurable number of base stations is selected from an active set of base stations and the active set of base stations is selected from the plurality of base stations. The configurable number is at least two.

In yet another embodiment, a radio network controller that may be used in a manifold network wireless communication system is provided. One embodiment of the radio network controller can be configured to be communicatively coupled to a plurality of base stations that provide wireless connectivity within a geographic area such that user equipment in the geographic area maintain a substantially continuous call connection with at least two of the plurality of base stations. The radio network controller can be configured to select an active set of base stations from the plurality of base stations for the user equipment and to select a configurable number of the plurality of base stations from the active set to maintain the substantially continuous call connection with the user equipment. The configurable number is at least two.

In a further embodiment, a base station that may be used in a manifold network wireless communication system is provided. One embodiment of the base station can be deployed as one of a plurality of base stations that provide wireless connectivity within a geographic area such that user equipment in the geographic area maintain a substantially continuous call connection with at least two of the plurality of base stations. The base station can be configured to be communicatively coupled to a radio network controller that is communicatively coupled to the plurality of base stations. The radio network controller can be configured to select an active set of base stations from the plurality of base stations for the user equipment and to select a configurable number of the plurality of base stations from the active set to maintain the substantially continuous call connection with the user equipment. The configurable number is at least two.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a manifold network wireless communication system;

FIG. 2 conceptually illustrates a second exemplary embodiment of a manifold network wireless communication system;

FIG. 3 conceptually illustrates one exemplary embodiment of a method for determining an active set of base stations associated with user equipment;

FIGS. 4A and 4B depict changes in the mapping of connection code bits to base stations in an active set in two exemplary situations;

FIG. 5 conceptually illustrates one exemplary embodiment of a method for selecting a manifold set of base stations to form concurrent call connections with user equipment;

FIGS. 6A and 6B depict changes in the values of connection code bits during slow or fast fading;

FIG. 7 conceptually illustrates a plot of signal strength associated with different base stations and active set for user equipment;

FIG. 8 conceptually illustrates a Markov chain state diagram that is used to simulate the performance of a manifold network wireless communication system;

FIG. 9 conceptually illustrates a T-test distribution for simulations using different embodiments of manifold network wireless communication system, such as the embodiments depicted in FIG. 8;

FIGS. 10A, 10B, 10C, and 10D conceptually illustrate different model scenarios used to simulate wireless communication in a manifold network wireless communication system; and

FIGS. 11A-H show dropped call results for systems having different nesting levels, different numbers of user equipment, and different durations.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter.

Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and custom-ary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

Wireless communication systems drop a significant percentage of calls. Dropped calls are often caused by slow fading that occurs when obstructions come between a mobile unit and the base station that is serving the mobile unit. By one estimate, 2% of all calls in wireless networks are dropped. Other estimates have set the call drop rate in some circumstances or for some providers as high as 4.5%. Dropped calls incur significant financial costs. For example, service providers annually invest billions of dollars to improve the quality of their wireless networks, at least in part to reduce the number of call drops because dropped calls can lead to user dissatisfaction and subscriber churn. Dropped calls also incur significant social costs. For example, in 2011, cell phones were used to summon help for an estimated 19,000,000 emergencies worldwide. Approximately 531,000 of these emergency calls were dropped. Additional discussion of the social and economic cost of dropped calls may be found in Appendix I.

The call drop rate can be reduced by implementing a manifold network wireless communication system. As used herein, the phrase “manifold network wireless communication system” will be understood to refer to a network of base stations that provide overlapping coverage areas so that user equipment in the manifold network wireless communication system are substantially continuously communicating with multiple base stations for the duration of each call. Deploying base stations in this manner may be referred to as providing “ubiquitous macrodiversity” because multiple base stations provide macrodiversity signals at each location within the geographic area. As used herein, the term “macrodiversity” will be understood to refer to the use of multiple transmitter or receiver antennas to transfer copies of the same signal along different paths from the transmitter to the receiver. The distance between the macrodiversity transmitter antennas is longer than the wavelength of the transmitted signal, which contrasts with microdiversity transmitters that include multiple antennas separated by a distance that is less than or on the order of the wavelength of the transmitted signal.

Base stations in a manifold network wireless communication system may be associated with different mobile units on the basis of signal strength indicators for signals transmitted between the base stations and the mobile units. Exemplary signal strength indicators include received signal strength indicators that indicate the total strength of signals received at each base station from the mobile units served by the base station, a ratio of the chip energy (E_{c}) received at the mobile unit in a pilot signal transmitted by a base station to the total wideband noise (Iₒ) measured by the mobile unit, or transmitted signal strength indicators determined by the mobile unit. User equipment moving through the manifold network wireless communication system maintains substantially continuous communication sessions with more than one base station. In one embodiment, the number or identities of base stations that maintain contact with the user equipment can be negotiated between the user equipment and the system. In one embodiment, the number of base stations that provide overlapping coverage to regions within the system can be set by defining a nesting level for the wireless communication system. The nesting level indicates the number of base stations that are able to provide wireless connectivity to user equipment at a particular location within the system.

The identities of the base stations that maintain communication systems with user equipment can be identified by the values of bits stored by the user equipment and the system. These bits may be referred to as connection codes. Each bit can be associated with a different base station and the associations of the bits with the base stations can be negotiated and modified as the user equipment moves through the system. The bits can then be used to signal changes in the serving base stations, e.g., when slow fading is detected for one or more of the serving base stations. Using the negotiated bits instead of the full base station identifiers significantly reduces the overhead required to identify the serving base stations or to switch between different serving base stations. In one embodiment, the base stations that maintain communication with the user equipment are selected using signal strength indicators such as the ratio Ec/Iₒ, the received signal strength indicator (RSSI), or the transmitted signal strength indicator (TSSI). In some embodiments, standardized air interface measurements such as intra-frequency measurements, inter-frequency measurements, inter-radio access technology measurements, traffic volume, quality, internal user equipment measurements, or user equipment positioning measurements may be used to gauge the channel quality.

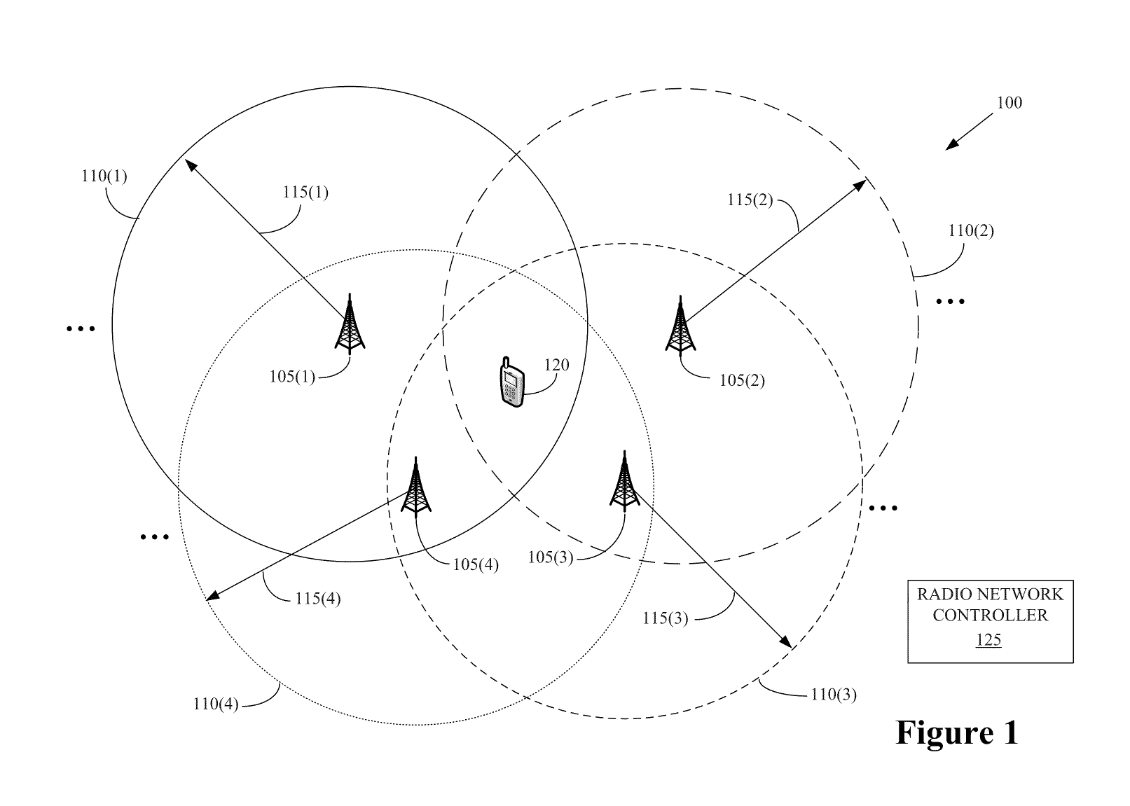

FIG. 1 conceptually illustrates a first exemplary embodiment of a manifold network wireless communication system 100. In the illustrated embodiment, base stations 105 are configured and deployed to provide wireless connectivity to overlapping geographic areas or cells 110. In the interest of clarity, the cells 110 are depicted as circles having a radius 115 that can be determined by a pilot signal strength transmitted by the corresponding base station 105. However, persons of ordinary skill in the art having benefit of the present disclosure should appreciate that the coverage areas of actual base stations may differ from the idealized circular shapes, e.g. due to the presence of structures, geographical features, antenna design, radio frequency propagation effects, radiofrequency settings, and the like. Furthermore, the boundaries of the geographic areas 110 may be time variable, e.g. they may change in response to variations in transmission power, geography, the man-made environment, environmental conditions, and the like. Moreover, some base stations 105 may be configured to provide wireless connectivity in portions of the cells 110, such as individual sectors of the cells 110. As used herein, the term “cell” will be understood to refer to any geographic area covered by a base station. Persons of ordinary skill in the art having benefit of the present disclosure should also appreciate that the term “base station” is used herein to refer to any physical device that is used to support wireless connectivity and so the term “base station” may also refer to devices such as base station routers, access points, wireless routers, femtocells, and the like.

The cells 110 overlap so that more than one cell 110 can provide wireless connectivity to user equipment 120. In the illustrated embodiment, overlapping of the cells 110 allows the four base stations 105 to provide wireless connectivity to user equipment 120 so that the user equipment 120 can potentially form call connections with four base stations 105. Control or data information can therefore be simultaneously or concurrently transmitted between the user equipment 120 and the base stations 105 that have a call connection to the user equipment 120. The number of base stations 110 that are able to provide wireless connectivity to user equipment 120 at a particular location within the system 100 may be referred to as the “nesting level” of the system 100. In various embodiments, the nesting level of the system 100 may vary from one (e.g., a conventional system) to higher nesting levels and may also vary with location throughout the system 100. For example, the nesting level that one location may be n=3 so that three base stations 110 are able to provide wireless connectivity to the location and the nesting level may be n=4 at a different location in the system 100 so that four base stations 110 are providing wireless connectivity.

In one embodiment, the pattern of overlapping cells 110 may be repeated over a geographic area that extends beyond the region depicted in FIG. 1. Base stations may be deployed throughout this geographic area to provide coverage at a configurable or selected nesting level and therefore provide ubiquitous macrodiversity throughout the geographic area. User equipment 120 may be substantially continuously in contact with multiple base stations 110 as the user equipment 120 moves through the geographic area. As used herein, the term “substantially continuously” means that under normal conditions the user equipment 110 can establish a call connection with multiple base stations 110 from any position within the geographic area that provides ubiquitous macrodiversity. However, persons of ordinary skill in the art having benefit of the present disclosure should appreciate that conditions such as fading may make it difficult or impossible to establish a call connection with one or more base stations 110 for some period of time, which is usually short relative to the duration of a call although in some cases a fade may last for a significant portion or the entirety of a call.

User equipment 120 can be associated with an active set of base stations 110. In the illustrated embodiment, a radio network controller 120 is physically, electromagnetically, or communicatively coupled to the base stations 110. The radio network controller 125 may select the active set of base stations for the user equipment 120 from the base stations that are deployed in the wireless indication system 100. For example, the Radio Network Controller may associate the set of four base stations 110(1-4) with the user equipment 120. Selection of the active set of base stations may be performed based upon measurements of signals transmitted over the air interface such as signal strength measurements, channel quality information, channel state information, and the like. The Radio Network Controller 125 may also associate the base station 110 in the active set with bits in a connection code that is stored in the RNC 125. For example, if the active set can include a maximum number of four base stations, the connection code may include four bits and one of the bits may be associated with each of the base stations 110(1-4).

The Radio Network Controller 125 may also select a subset of the base stations 110 from the active set for communication with the user equipment 120. In one embodiment, the

Radio Network Controller 125 may be configured to select two base stations 110 from the active set so that call connections can be formed between the user equipment 120 and the two selected base stations 110. However, in alternative embodiments, the Radio Network Controller 125 may be configured to select some other configurable number (greater than or equal to two) of base stations 110 to form call connections with the user equipment 120. The base stations 110 may be selected from the active set based on signal strength measurements performed by user equipment 120 or base stations 110 such as measurements of the ratio E_{c}/I₀, a received signal strength indicator (RSSI) or a transmitted signal strength indicator (TSSI). The RSSI is a measurement of the power present in a received radio signal. Measurements of RSSI may be done in the intermediate frequency (IF) stage before the IF amplifier and are typically performed by the base station 110 every 100 ms. In zero-IF systems, measurements of RSSI may be performed in the baseband signal chain before the baseband amplifier. The RSSI measures the signal strength for signals received from all the user equipment 120 served by the base station 110 and may therefore provide an indication of the loading of the base station 110. A transmitted signal strength indicator (TSSI) circuit provides an indication of the transmitter output power. The ratio E/I₀ is a measure of signal to noise as measured by the mobile equipment which indicates the base station signal quality. Values of the bits in the connection code may be used to indicate which base stations 110 are selected for communication with user equipment 120, as discussed herein.

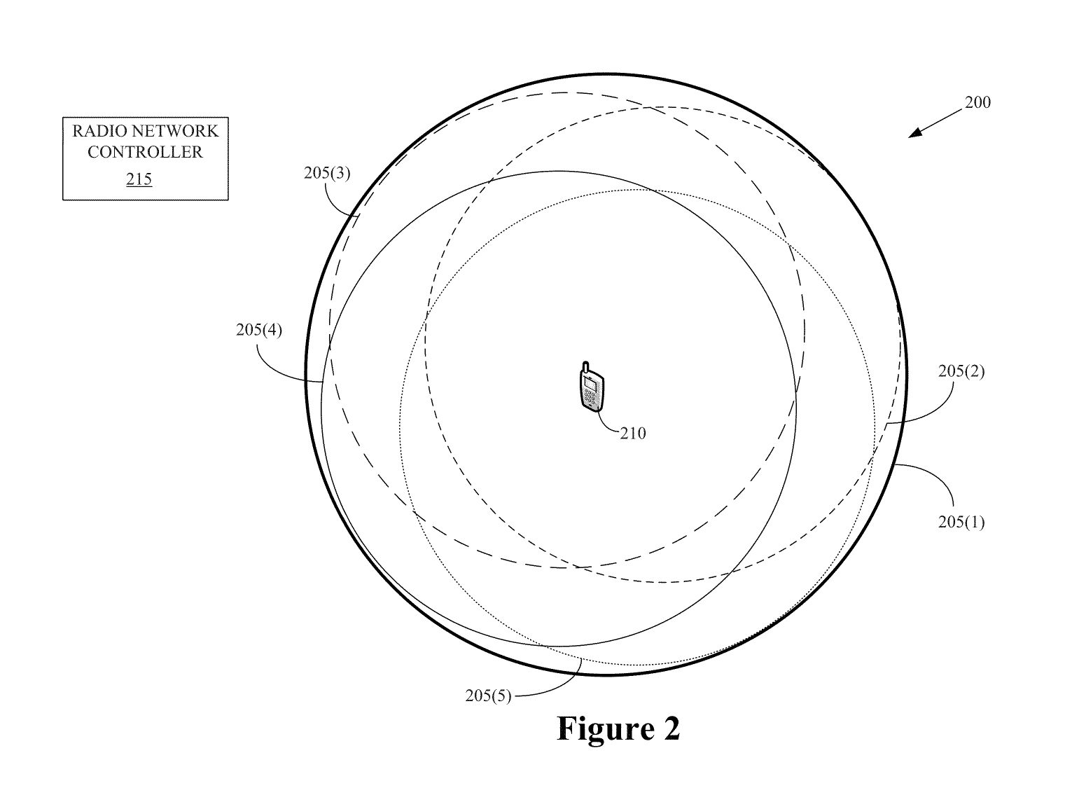

FIG. 2 conceptually illustrates a second exemplary embodiment of a manifold network wireless communication system 200. In the second exemplary embodiment, base stations (not shown in FIG. 2 in the interest of clarity) are configured and deployed to provide wireless connectivity to overlapping cells 205. As discussed herein, cells 205 are depicted as circles but persons of ordinary skill in the art having benefit of the present disclosure should appreciate that the coverage areas of actual base stations may differ from the idealized circular shape, e.g. due to the presence of structures, geographical features, antenna design, radio frequency propagation effects, radiofrequency settings, and the like. Furthermore, the boundaries of the cells 205 may be time variable, e.g. in response to variations in transmission power, geography, the man-made environment, environmental conditions and the like. The cells 205 overlap so that more than one cell 205 can provide wireless connectivity to user equipment 210. In the illustrated embodiment, overlapping of the cells 205 allows as many as five base stations to provide wireless connectivity to user equipment 210. Control or data information can therefore be simultaneously or concurrently transmitted between the user equipment 210 and the base stations that have a call connection to the user equipment 210.

The second exemplary embodiment differs from the first exemplary embodiment shown FIG. 1 because cell 205(1) is an overlying cell whose boundaries encompass the boundaries of the cells 205(2-5). Persons of ordinary skill in the art having benefit of the present disclosure should appreciate that in actual deployments the boundaries of the cells 205 may be time variable and may not be precisely defined so that portions of the cells 205(2-5) may extend beyond the boundary of the cell 205(1). Nevertheless, the overlying cell 205(1) substantially encompasses the cells 205(2-5) when most of the area of the cells 205(2-5), e.g. the portions of the cells 205(2-5) that receive the strongest pilot signal strengths from the corresponding base station or pilot signal strengths above a threshold value, are within the boundary of the overlying cell 205(1). As discussed herein, the pattern of overlapping cells 205 may be repeated over a geographic area that extends beyond the region depicted in FIG. 2. Base stations may be deployed throughout this geographic area to provide ubiquitous macrodiversity at a configurable or selected nesting level.

In one embodiment, the overlying cell 205(1) may be assigned a lower priority than the cells 205(2-5). A Radio Network Controller 215 may then maintain records of the identities of the overlying cells 205(1) and the relative priorities of the cells 205(1-5). As discussed herein, the Radio Network Controller 215 may also include functionality that can be configured to add or remove cells 205 to or from the active set for the user equipment 210, associate the cells 205 in the active set with connection codes, select which cells from the active set can establish a call connections with the user equipment 210, set values of the bits in the connection codes to indicate the cells that have been selected from the active set to establish a call connections with the user equipment 210, or unset values of the bits in the connection codes to indicate the cells that have been removed from the set having call connections with the user equipment 210. In one embodiment, the Radio Network Controller 215 may perform one or more of these operations based upon the relative priorities of the cells 205. For example, the Radio Network Controller 215 may preferentially select the active set from among the higher priority base stations 205(2-5) regardless of the relative signal strength of the cells 205(2-5) and the overlying cell 205(1). However, if there are not enough higher priority base stations 205(2-5) available for the active set, e.g. because an insufficient number of the base stations 205(2-5) have signal strengths high enough to support call connections with the user equipment 210, then the Radio Network Controller 215 may add the overlying base station 205(1) to the active set so that it is available to establish call connections with the user equipment 210.

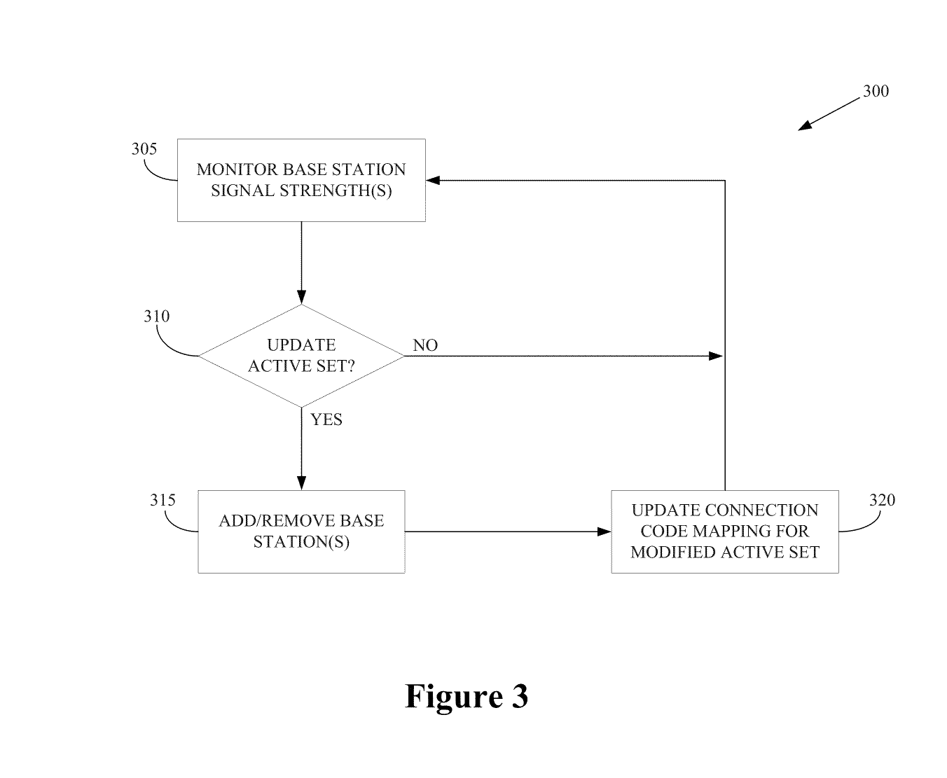

FIG. 3 conceptually illustrates one exemplary embodiment of a method 300 for determining an active set of base stations associated with user equipment. In one embodiment, the method 300 may be implemented in a Radio Network Controller such as the Radio Network Controllers 125, 215 shown in FIGS. 1-2. However, in alternative embodiments, portions of the method 300 may be implemented in other entities in the manifold network wireless communication system. Signal strengths associated with the base stations may be monitored (at 305). In one embodiment, base stations may monitor a received signal strength to determine an RSSI value and user equipment may monitor the ratio E_{c}/I₀ to determine the base station signal quality as seen by the user equipment. This information may be conveyed to the Radio Network Controller, which may use the information to determine (at 310) whether the active set associated with the user equipment should be modified.

In one embodiment, the Radio Network Controller may decide (at 310) to update the active set when a signal strength associated with one or more candidate base stations exceeds an “add threshold” for a selected period of time (e.g., a time-to-trigger) or when a signal strength associated with one or more base stations in the active set drops below a “drop threshold” for a time interval that is longer than a configurable value. For example, if the signal strength associated with a base station exceeds the add threshold for the selected time interval, the base station may be added (at 315) to the active set. For another example, if a base station goes into a fade for a time that is longer than the selected time interval, that base station may be removed (at 315) from the active set. A hysteresis may be provided by setting the add threshold at a higher level than the drop threshold. The hysteresis may help to prevent or reduce flip-flopping that may occur when base stations are rapidly added or removed from the active set. The active set may also be updated (at 310) when the additions of base stations to the active set have made the active set larger than a configurable maximum number of base stations. For example, user equipment may support an active set list of up to six base stations.

A limited number of connection code bits are available to identify the base stations in the active set of user equipment. In one embodiment, the nesting level for the ubiquitous macrodiversity is 4 and so four connection code bits are available to identify four base stations as being part of the active set of user equipment. The mapping of the connection code bits to the base stations in the active set may therefore be renegotiated or modified (at 320) in response to changes in the base stations in the active set. In one embodiment, user equipment and the Radio Network Controller store values of the connection code bits. For example, user equipment stores values of the connection code bits that indicate the base stations in the user equipment's active set. The Radio Network Controller may include a database of connection code bits associated with the base stations or user equipment served by the Radio Network Controller. The user equipment and the Radio Network Controller may also store information indicating the mapping of the connection code bits to the different base stations in the active set.

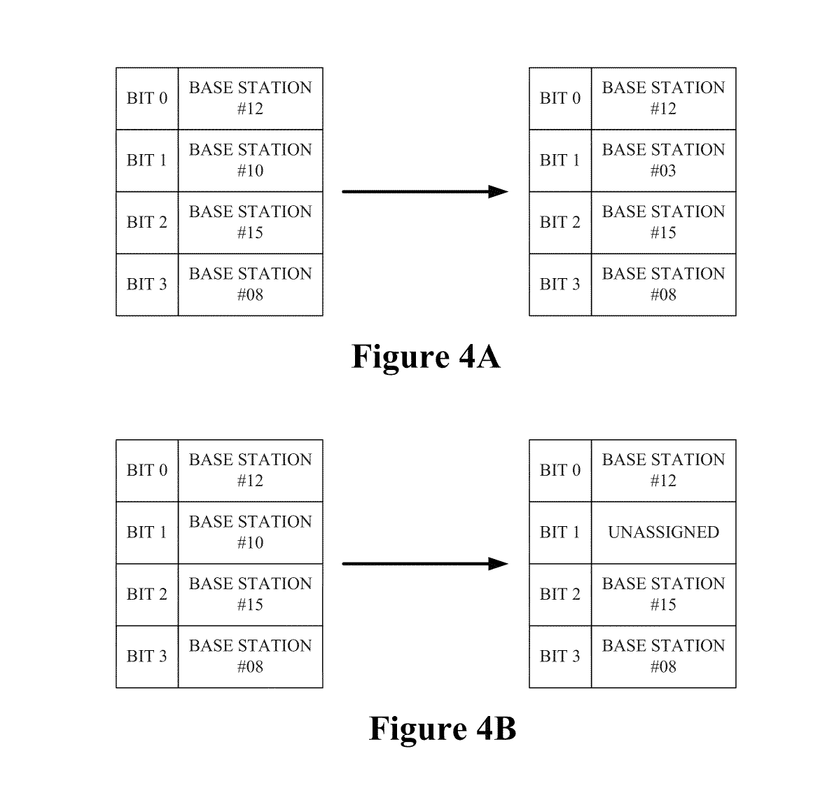

FIGS. 4A and 4B depict changes in the mapping of the connection code bits to the base stations in an active set in two exemplary situations. In both cases, the active set of the user equipment initially includes base stations #12, #10, #15, and #08. Bit 0 of the connection code is initially allocated to base station #12, bit 1 is initially allocated to base station #10, bit 2 is initially allocated to base station #15, and bit 3 is initially allocated to base station #08. In one embodiment, the base stations may be identified by a base station identifiers, serial numbers, or other numbers that may uniquely identify the base station in the wireless communication system.

FIG. 4A shows updates to the mapping that occur when the signal strength associated with base station #10 drops below the drop threshold for a time interval longer than the configurable value and the signal strength associated with a new base station #03 is above the add threshold for longer than the time-to-trigger. The base station #10 may then be removed from the active set and the base station #03 may be added to the active set for the user equipment. The connection codes for the user equipment may then be modified or updated so that bit 0 of the connection code is allocated to base station #12, bit 1 is allocated to base station #03, bit 2 is allocated to base station #15, and bit 3 is allocated to base station #08.

FIG. 4B shows updates to the mapping that occur when the signal strength associated with base station #10 drops below the drop threshold for a time interval longer than the configurable value but no new base stations have a sufficiently strong signal strength to be added to the active list. The base station #10 may be removed from the active set for the user equipment. The connection codes for the user equipment may be modified or updated so that bit 0 of the connection code is allocated to base station #12, bit 1 is not assigned to a base station, bit 2 is allocated to base station #15, and bit 3 is allocated to base station #08. Another base station may be allocated to bit 1 if the signal strength associated with the other base station subsequently rises above the add threshold for longer than the time-to-trigger.

In one embodiment, base stations in the active set may also be associated with a discard set. The discard set is a set of base stations that are currently members of the active set but may be dropped because their signal strength no longer satisfies the thresholds for signal strength quality (e.g., E_{c}/I₀, RSSI, or TSSI). For example, if a signal strength associated with a base station goes below a drop threshold, a drop timer is activated, and the base station is placed in the discard set. If the signal strength of the base station rises back above the drop level, the drop timer may be reset and the base station may be removed from the discard set. However, if the signal strength level of the base station remains below the drop threshold and the drop timer expires, then the base station may be dropped from the active set.

A candidate set may include neighboring base stations that may be potential new members of the active set. Membership in the candidate set may be determined by a quality indicator that represents signal strength (e.g., E_{c}/I₀, RSSI, or TSSI) or using other criteria. As the user equipment moves throughout the network, base stations that have a strong enough signal strength to serve the call may be put into the candidate set so that they may subsequently be added to the active set.

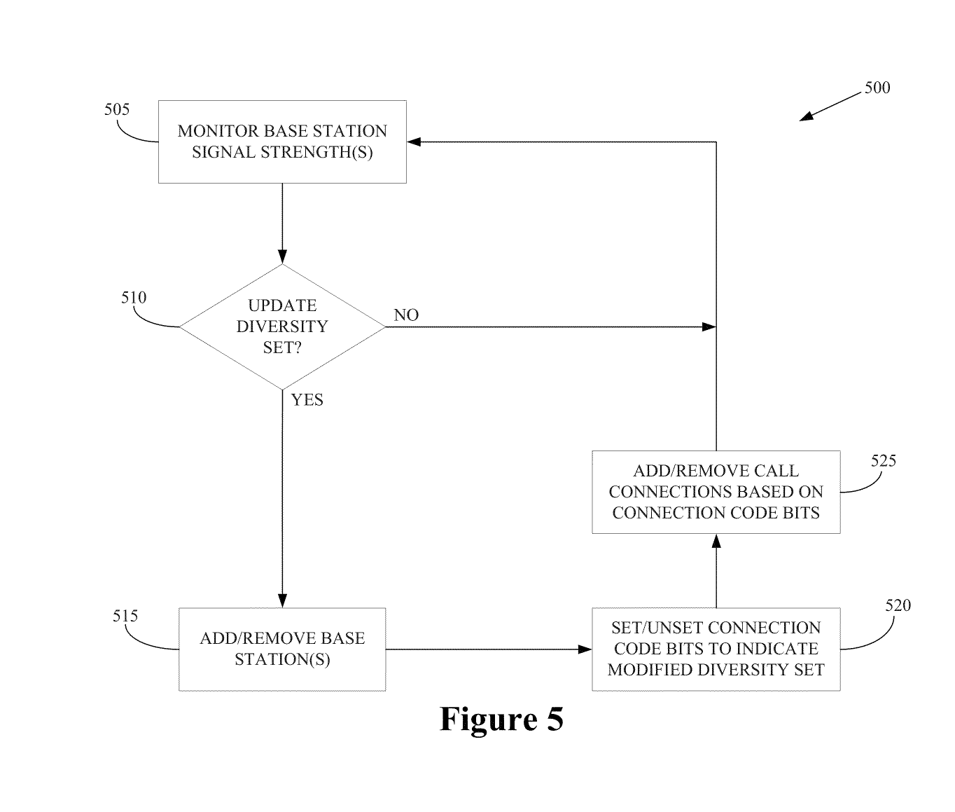

FIG. 5 conceptually illustrates one exemplary embodiment of a method 500 for selecting a manifold network including a manifold set of base stations that can form concurrent call connections with user equipment. The manifold set of base stations may be selected from the active set associated with user equipment. In the illustrated embodiment, base station signal strengths are monitored (at 505) for the base stations in the active set of the user equipment. In one embodiment, user equipment may monitor (at 505) the E_{c}/I₀ ratio to ascertain base station signal strength. The user equipment may monitor (at 505) the E_{c}/I₀ ratio concurrently with measurements of an RSSI value performed by one or more base stations. The network may use the RSSI value(s) as a measure of uplink load on the corresponding base station. The user equipment may also measure (at 505) the base station transmitted signal strength or a corresponding TSSI value. The E_{c}/I₀ ratio, the RSSI, or the TSSI may be used in various combinations to provide an indication of the base station signal quality. For example, the user equipment or the base station(s) may convey the E/I₀ ratio, the RSSI, or the TSSI to the Radio Network Controller, which may use the information to determine (at (510) whether the manifold set associated with the user equipment should be modified.

In one embodiment, the Radio Network Controller may decide (at 510) to update the manifold set based on a comparison of signal strengths associated with one or more base stations in the active set. For example, initially a first and a second base station are in the manifold set and have established a call connection with the user equipment. The first and second base stations have the highest signal strengths from among the base stations in the active set. However, the third base station may be added (at 515) to the manifold set and the first or second base station may be removed (at 515) from the manifold set if the signal strength associated with a third base station becomes larger than the signal strength associated with either the first or second base stations for longer than a selected time interval. For example, the relative signals strengths of base stations may change because of an increase in the signal strength of the third base station or a decrease in the signal strength of the first or second base stations or a combination thereof. The Radio Network Controller may then change values (at 520) of connection code bits to indicate the modification to the manifold set. For example, the Radio Network Controller may set (at 520) the value of a connection code bit to 1 to add the corresponding base station to the manifold set. For another example, the Radio Network Controller may “unset” (at 520) the value of a connection code bit by changing its value to 0 to remove the corresponding base station from the manifold set. The base stations and user equipment may then establish or tear down call connections (at 525) based on the information indicated in the modified connection code bits.

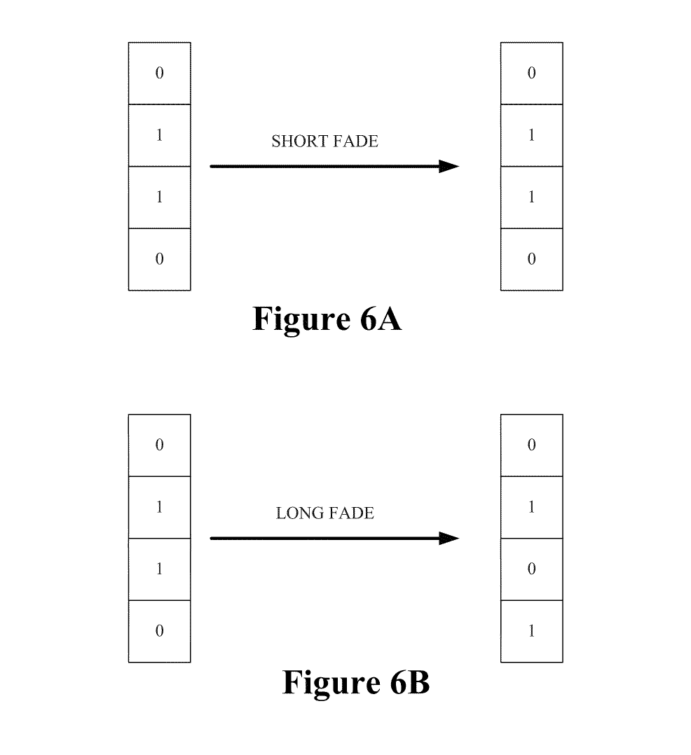

FIGS. 6A and 6B depict changes in the values of the connection code bits during fast or slow fading. In both cases, the active set of the user equipment initially includes four base stations and the manifold set includes a maximum of two base stations. Bit 0 of the connection code is initially set to 0 to indicate that this base station is not in the manifold set, bit 1 is initially set to 1 to indicate that this base station is in the manifold set, bit 2 is initially set to 1 to indicate that this base station is in the manifold set, and bit 3 is initially set to 0 to indicate that this base station is not in the manifold set.

FIG. 6A shows updates to the connection bit values that occur when the base station associated with bit #3 goes into a slow fade. In this case, the base station remains in the manifold set. The user equipment can still communicate with the other base station in the manifold set over the existing call connection so the call is not dropped during the slow fade. When the base station comes out of the fade, the user equipment can communicate with both base stations in the manifold set over the existing call connections.

FIG. 6B shows updates to the connection bit values that occur when the base station associated with bit #3 goes into fast fading. In this case, the base station is removed from the manifold set once the fade exceeds a specified time interval and the base stations associated with bit #4 is added to the manifold set. For example, a Radio Network Controller may change the mapping of the connection code bits to base stations for the user equipment. The Radio Network Controller may then communicate with the user equipment and the relevant base stations to signal the new mapping so that the user equipment and the base stations understand the new mapping of the connection code bits to the different base stations. The user equipment drops the call connection to base station #3 and establishes a call connection to base station #4. The user equipment can then communicate with both base stations in the modified manifold set.

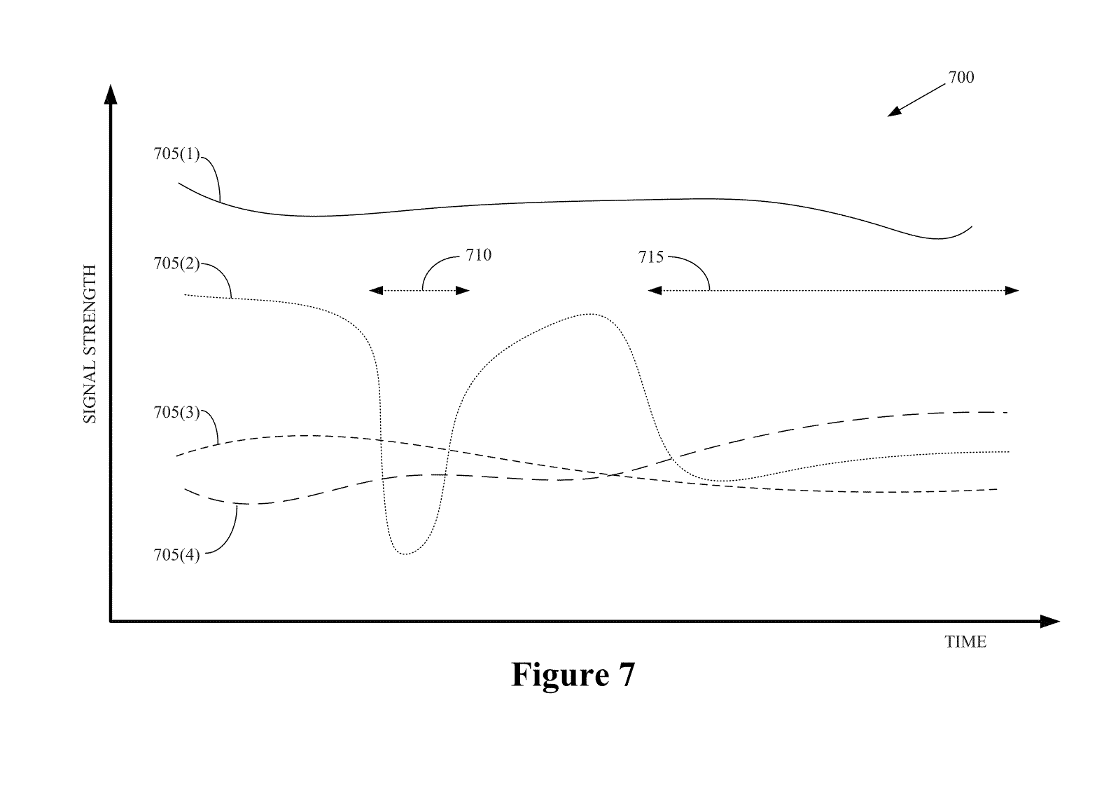

FIG. 7 conceptually illustrates a plot 700 of signal strength associated with different base stations in an active set for user equipment. In the illustrated embodiment, the vertical axis indicates the signal strength and the horizontal axis indicates increasing time. The signal strength may represent a ratio of the pilot signal chip energy to interference (E_{c}/I₀), transmitted signal strength, or another signal strength indicator that may be formed using combinations of E_{c}/I₀ and transmitted signal strength indications. Initially, at the far left of the plot 700, the manifold set for the user equipment includes base stations associated with the signal strengths 705(1-2) because these have the largest signal strength indicators from among the active set of base stations. One of the base stations 705(2) goes into a slow fade that lasts for a time interval 710 that is less than a threshold time interval for triggering a modification to the manifold set. The base station 705(2) therefore remains in the manifold set and the user equipment maintains the call connection with the other base station 705(1) in the manifold set.

In the illustrated embodiment, the base station 705(2) later goes into fast fading that lasts for a time interval 715 that is longer than the threshold time interval for triggering a modification to the manifold set, thereby triggering a renegotiation of the manifold set. The base station 705(2) is removed from the manifold set and the base station 705(4), which has the next highest signal strength at this time, is added to the manifold set. The user equipment maintains the call connection with the base station 705(1), drops the call connection with the base station 705(2), and establishes a new call connection with the base station 705(4) so that the user equipment can maintain concurrent communication to the base stations 705(1, 4).

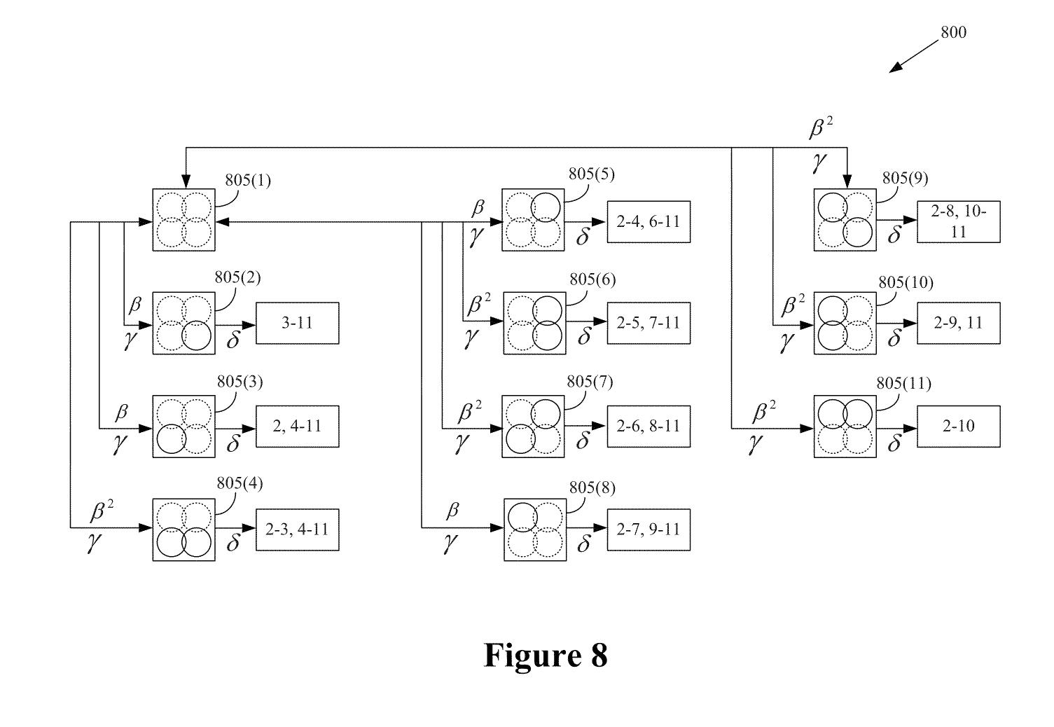

FIG. 8 conceptually illustrates a Markov chain state diagram 800 that is used to simulate the performance of a manifold network wireless communication system. In the illustrated embodiment, the active set is limited to four base stations that are indicated by the circles within the states 805. The manifold set can include up to two base stations and the base stations that are included in the manifold set for the state 805 and have call connections with the user equipment are indicated by circles with solid lines. The base stations that are not included in the manifold set for the state 805 are indicated by circles with dotted lines. Transitions between the different states 805 are indicated by the double headed arrows.

User equipment traverses the states 805 in the diagram 800 in response to changes in the connection coding indicating changes to the manifold set for the user equipment. The probability of a dropped call is indicated by β, the probability that a new call is established is indicated by γ, and the probability that a call is handed over between different cells as indicated by δ.

In the illustrated embodiment, the probability of a transition from left-to-right or top-to-bottom is indicated by the probability listed below the transition line and the probability of a transition from right-to-left or bottom-to-top is indicated by the probability listed above the transition line. For example, the probability of transitioning from state 805(3) to state 805(1) is β and the probability of transitioning from state 805(1) to state 805(3) is γ. The possible target states for a handoff are indicated by the boxes to the left of the state 805. For example, user equipment may be handed off from the state 805(2) to any of the states 805(3-11) with a probability of δ.

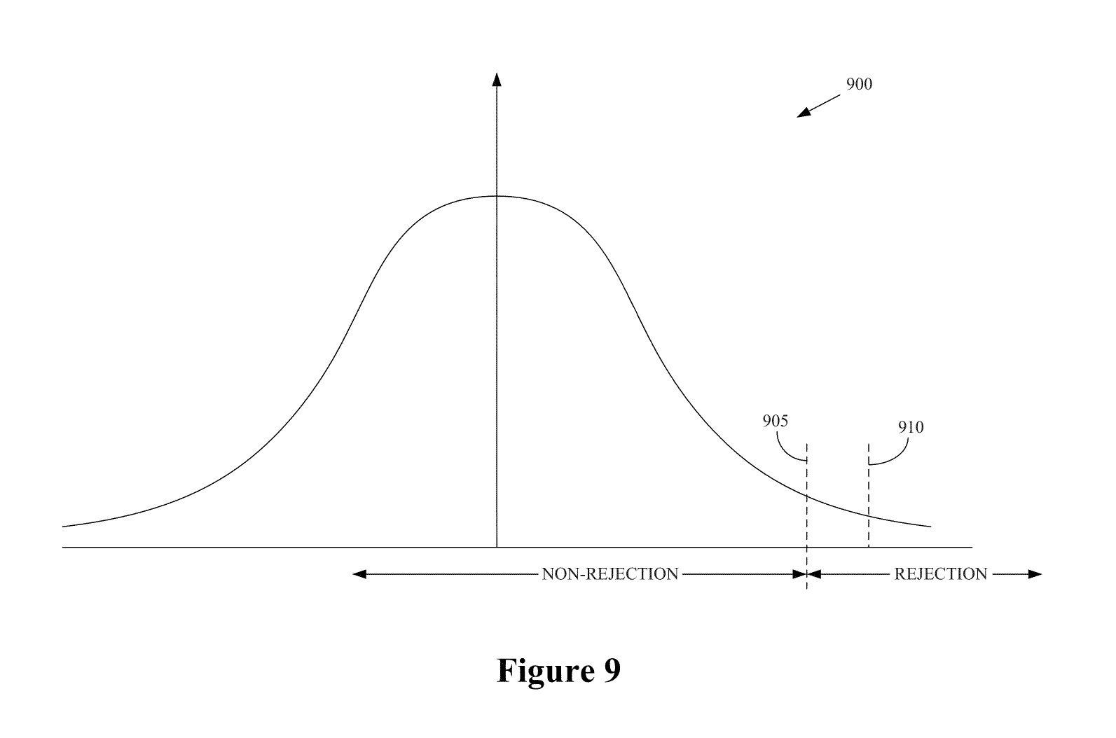

FIG. 9 conceptually illustrates a T-test distribution 900 for simulations using different embodiments of manifold network wireless communication system, such as the embodiments depicted in FIG. 8. In the illustrated embodiment, the T-test student distribution 900 is used to statistically show that the null hypothesis that a manifold wireless system shall have fewer call drops than a normal wireless system is accepted with very high confidence. The distribution 900 shows two critical points 905, 910. A value of the T-test statistic that falls on the critical point 905 indicates that there is a 95% possibility that the null hypothesis is accepted, e.g., the manifold network wireless communication system that generated the experimental data used to generate the T-test statistic will outperform a conventional wireless communication system. A value of the T-test statistic that falls on the second critical point 910 indicates that there is a 97.5% probability that the null hypothesis is accepted and the manifold network wireless system performs better than the conventional wireless system.

In the illustrated embodiment, data was collected on 20 experiments with nesting level coverage from 1 to 4. Each nesting level employed 20 experiments and had durations of either 50 or 320 time intervals. The critical point 905 for the illustrated embodiment has a value of 1.833 for the T-test student distribution 900. If the data collected for the experiments generated a value of the test statistic that was approximately 1.833 and therefore fell on the critical point 905, this would indicate that there is a 95% probability the manifold wireless system performs better than a normal wireless network, e.g. non-rejection of the null hypothesis. There would be only a 5% probability that a normal wireless network would perform better than the manifold wireless system, e.g. rejection of the null hypothesis. If the data collected for the experiments generated a value of the test statistic that corresponded to the second critical point 910, which has a value of approximately 2.262 in the illustrated embodiment, there would be a 97.5% probability that the manifold wireless system performs better than the conventional wireless system.

In fact, the value of the test statistic generated using the data collected for the embodiments of the manifold network wireless communication described herein is 16.0781. This value of the test statistic is significantly higher than either the value 1.833 for the critical point 905 or the value of 2.262 for the critical point 910. Consequently, the experimental data collected for the illustrated embodiments of the manifold network wireless communication system indicate that there is virtual certainty that the manifold system outperforms traditional wireless networks. Additional details of the simulation and the statistical analysis may be found in Appendix II.

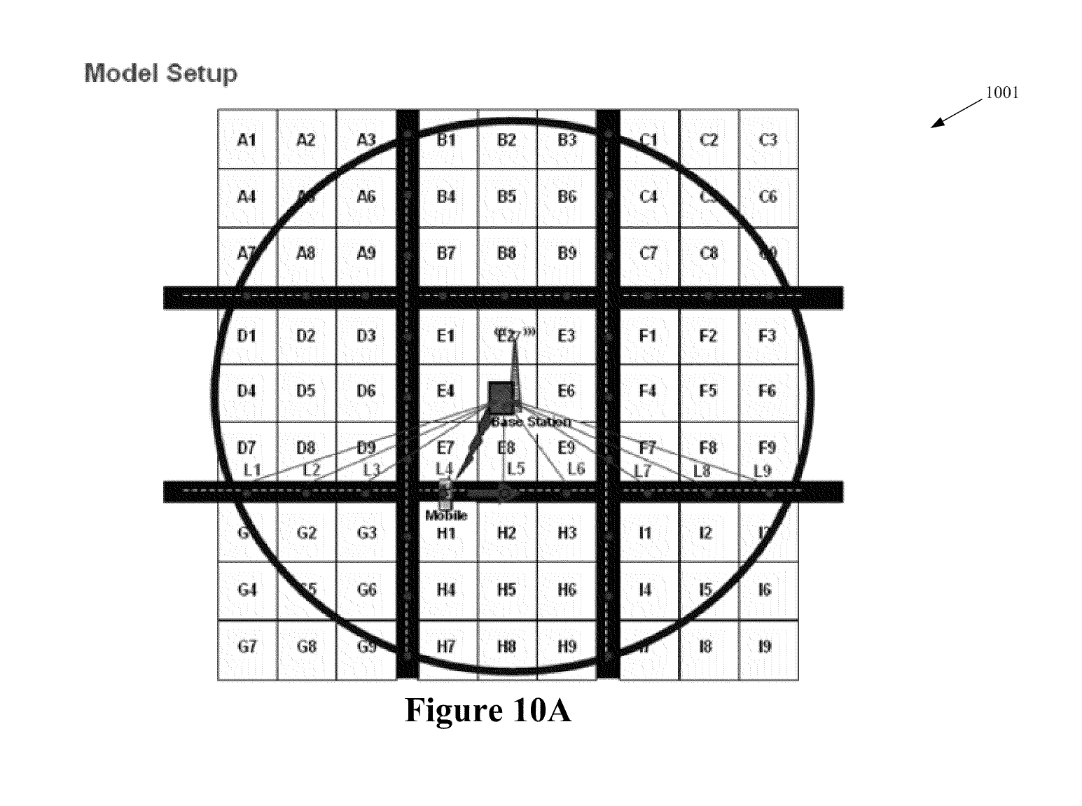

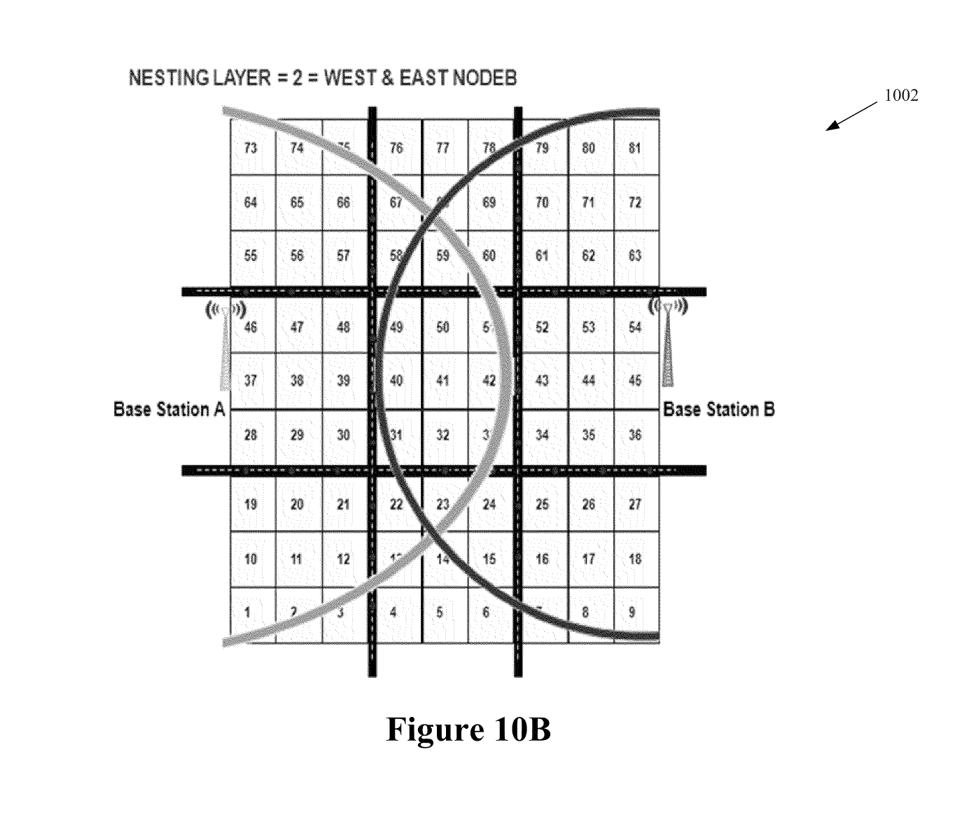

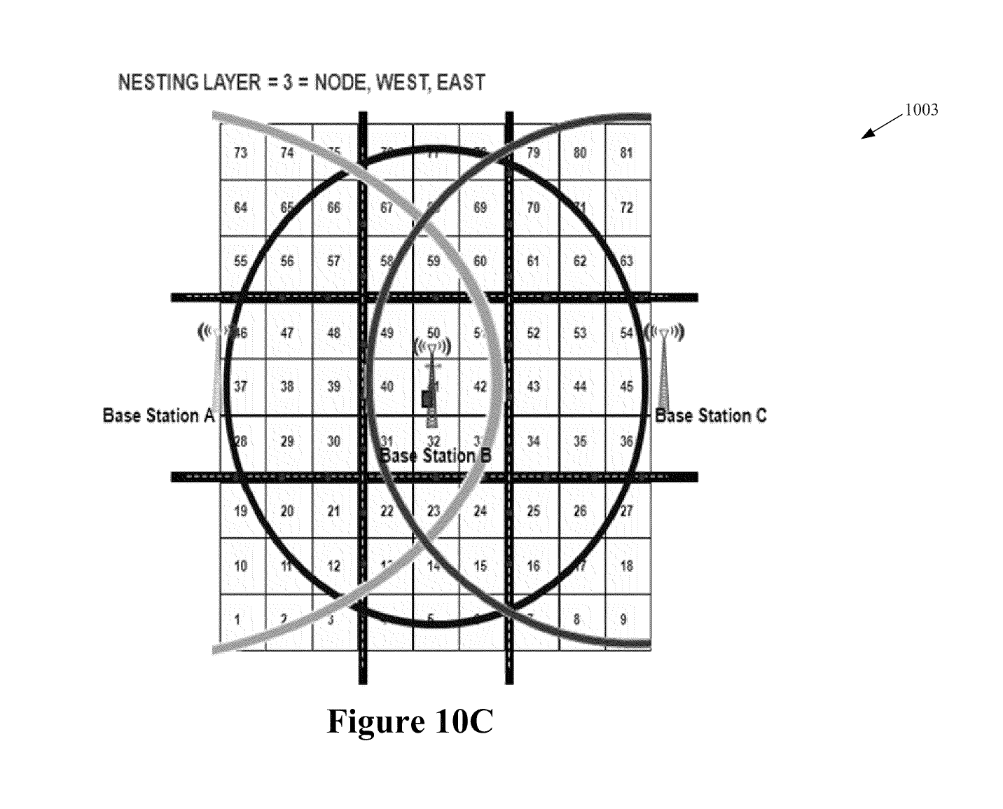

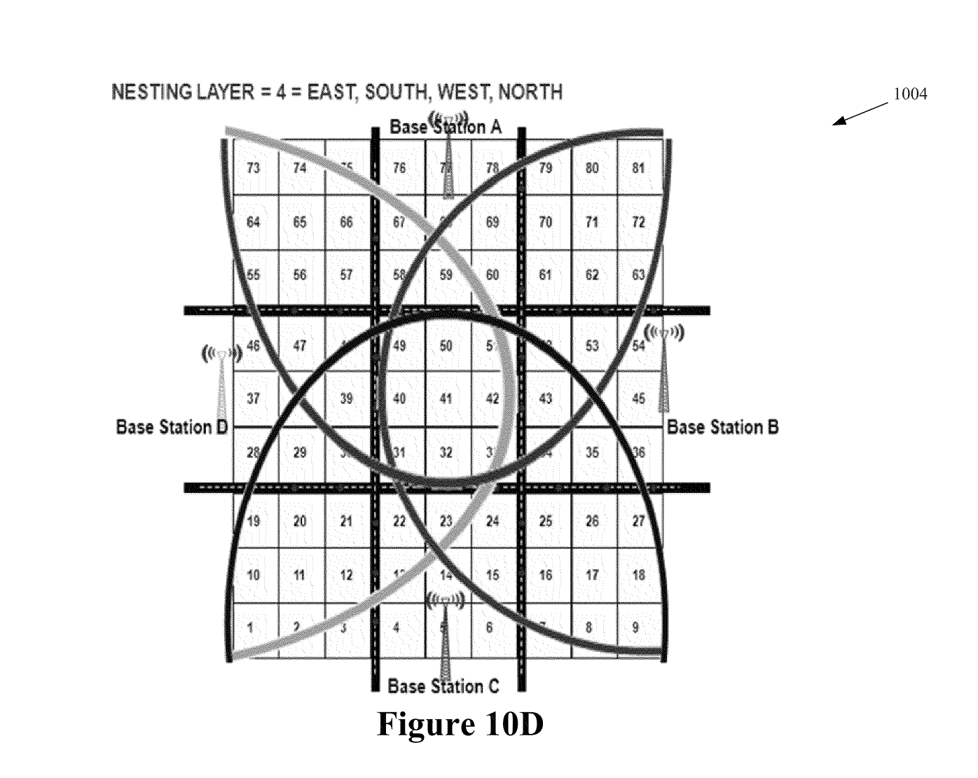

FIGS. 10A, 10B, 10C, and 10D conceptually illustrate different model scenarios 1001, 1002, 1003, 1004 used to simulate wireless communication in a manifold network wireless communication system. The model scenarios 1001, 1002, 1003, and 1004 are distinguished by having different nesting levels provided by different numbers of base stations. The base stations provide wireless connectivity to nine city blocks. The city blocks are labeled from A to I. Each of the city blocks is divided into nine zones. For example, the zones in city block A are labeled from A1 to A9. Furthermore, the coverage area of the base station has four roads. The four roads are laid out in a grid with two north-south roads and two east-west roads. User equipment such as smart phones carried by walking (or running) pedestrians or vehicular communication devices may move along the roads.

In a downtown metropolitan area, tall buildings may create shadow fading. Each city block in these simulations was zoned into nine areas. Each zone was either a tall building or a short building. Shadow fading exists when there is a large obstruction between the mobile and the base station. The simulation assigned either a tall or short building to each of the zones. Additional details may be found in Appendix III.

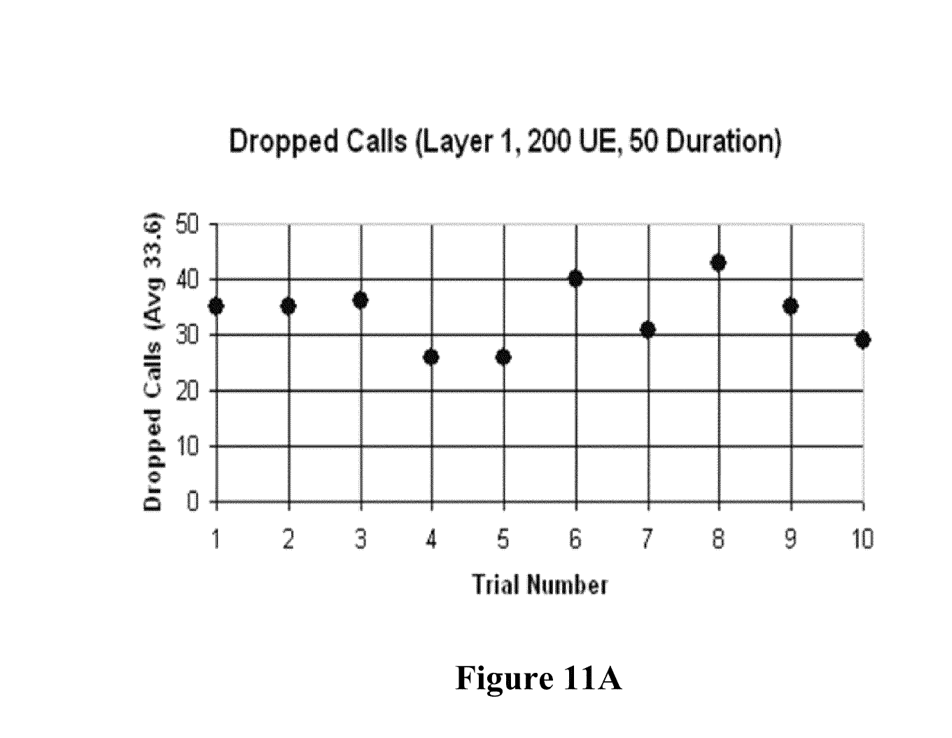

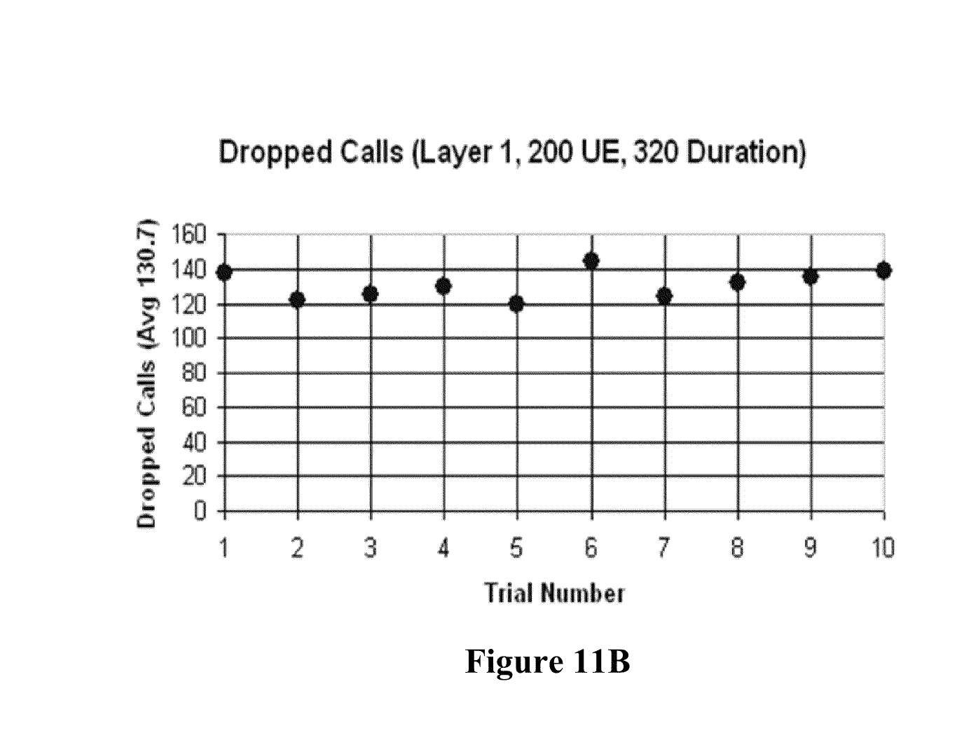

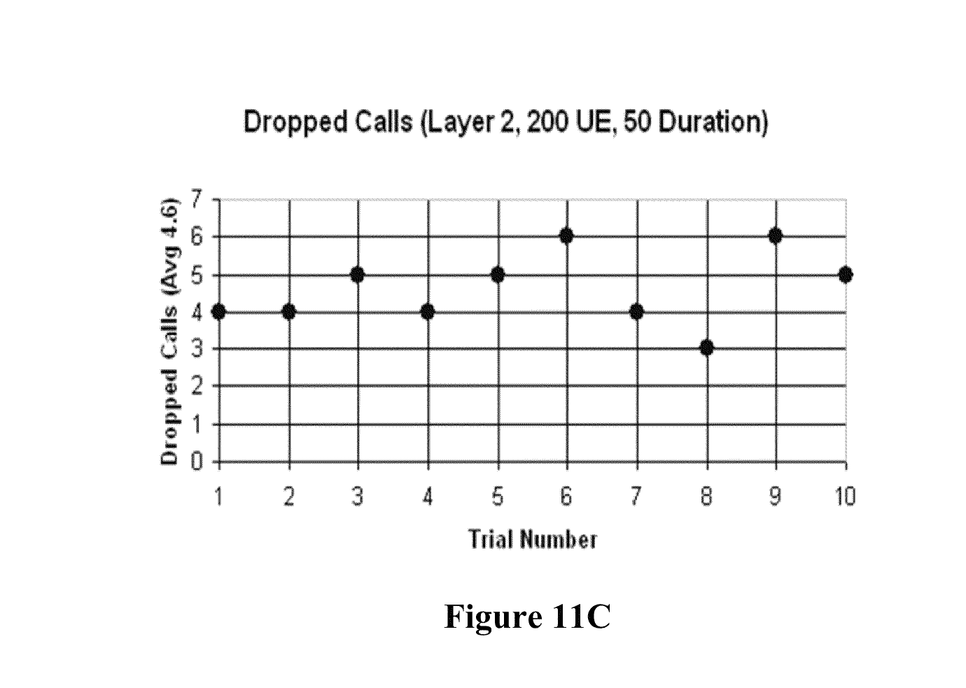

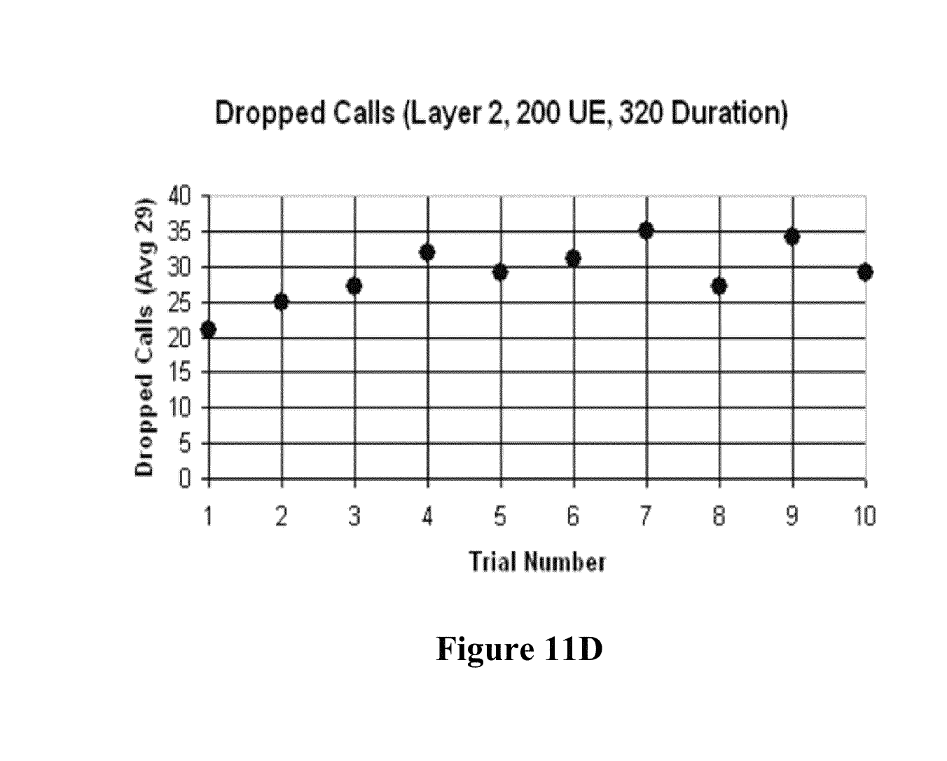

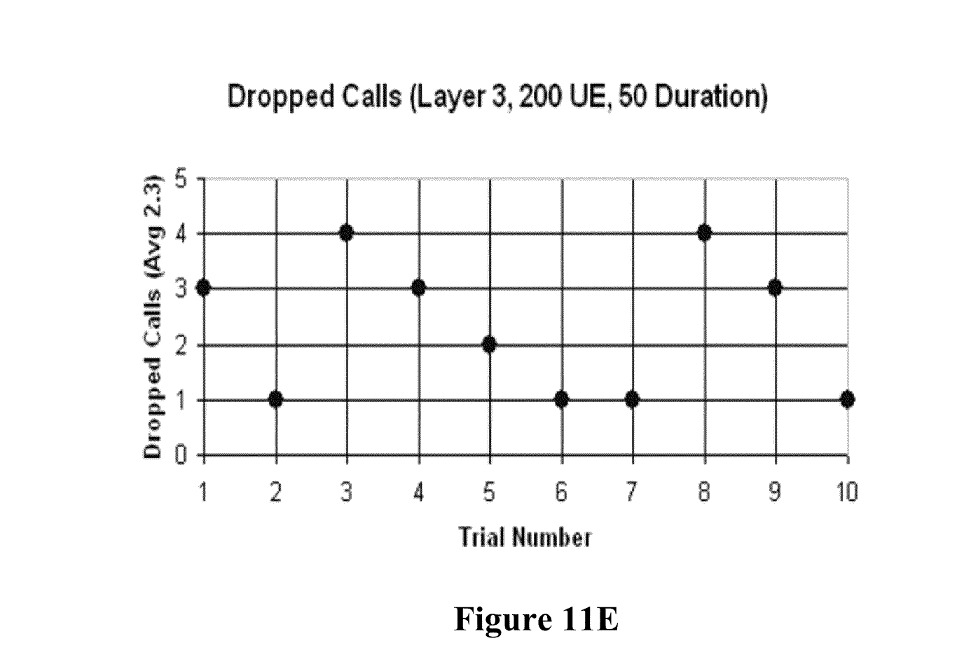

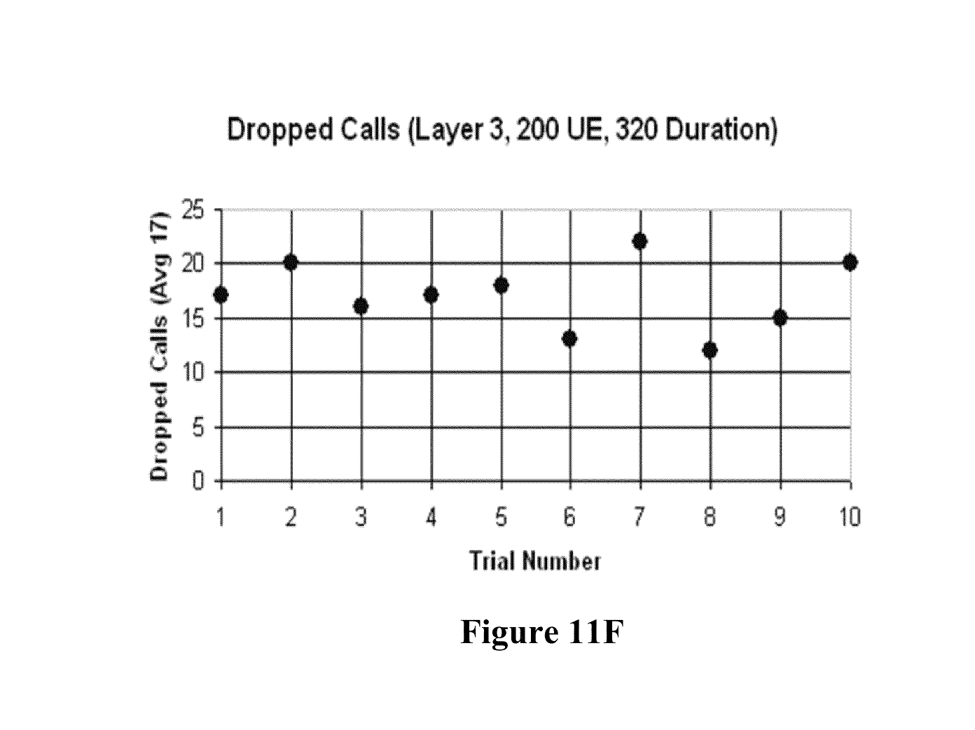

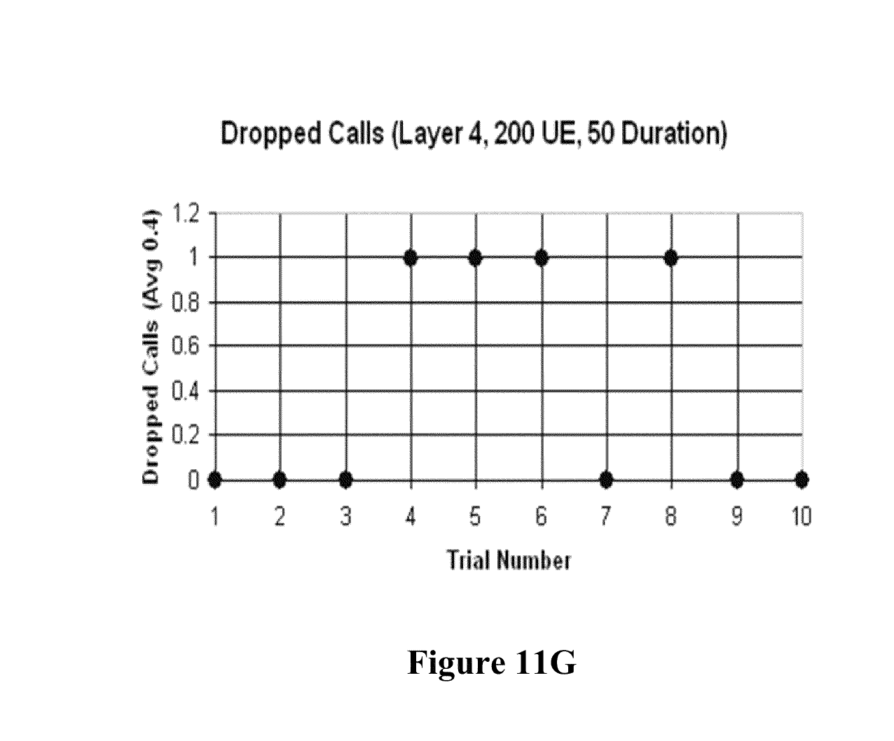

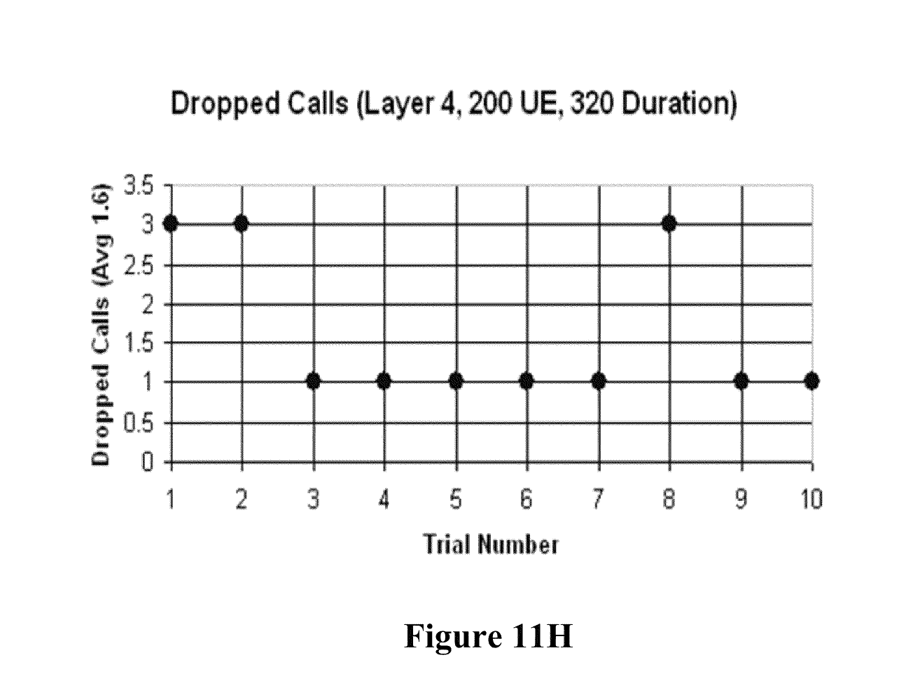

FIGS. 11A-H show dropped call results for systems having different nesting levels, different numbers of user equipment, and different durations. The experiment was repeated ten times in each of the embodiments depicted in FIGS. 11A-H. The number of dropped calls for each trial is indicated on the vertical axis and the horizontal axis indicates the trial number, which ranges from 1 to 10 to indicate the ten trials performed for each experiment. Additional details may be found in Appendix III.

The dropped call results for a system with nesting level of 1 that provides wireless connectivity to two hundred user equipment terminals (UEs) are shown in FIG. 11A. The duration was 50 iterations in the illustrated embodiment. The average number of dropped calls within the time period was 33.6. The standard deviation of the dropped calls was 5.62. The highest call drop value was 43, the lowest 26. A system with nesting level of 1 is equivalent to a conventional wireless system.

The dropped call results for a system with nesting level of 1 that serves two hundred UEs is shown in FIG. 11B. The duration was 320 iterations. The average number of dropped calls within the time period was 130.7. The standard deviation of the dropped calls was 8.13. The highest number of dropped calls was 139 and the lowest number of dropped calls was 122. A system with nesting level of 1 is equivalent to a conventional wireless system.

The dropped call results for a system with nesting level of 2 that serves two hundred UEs is shown in FIG. 11C. The duration was 50 iterations. The average number of dropped calls within the time period was 4.6. The standard deviation of the dropped calls was 0.97. The highest call drop value was 6, the lowest 3. A system with nesting level of 2 uses a manifold network wireless system such as embodiments of the manifold network wireless communication system described herein.

The dropped call results for a system with nesting level of 2 that serves two hundred UEs is shown in FIG. 11D. The duration was 320 iterations. The average number of dropped calls within the time period was 29.0. The standard deviation of the dropped calls was 4.24. The highest call drop value was 35, the lowest 21. A system with nesting level of 2 uses a manifold network wireless system such as embodiments of the manifold network wireless communication system described herein.

The dropped call results for a system with nesting level of 3 that serves two hundred UEs is shown FIG. 11E. The duration was 50 iterations. The average number of dropped calls within the time period is 2.3. The standard deviation of the dropped calls was 1.25. The highest call drop value was 4, the lowest 1. A system with nesting level of 3 uses a manifold network wireless system such as embodiments of the manifold network wireless communication system described herein.

The dropped call results for a system with nesting level of 3 serving two hundred UEs is shown FIG. 11F. The duration was 320 iterations. The average number of dropped calls within the time period was 17.0. The standard deviation of the dropped calls was 3.16. The highest call drop value was 22, the lowest 12. A system with nesting level of three uses a manifold network wireless system such as embodiments of the manifold network wireless communication system described herein.

The dropped call results for a system with nesting level of 4 that serves two hundred UEs is shown in FIG. 11G. The duration was 50 iterations. The average number of dropped calls within the time period was 0.4. The standard deviation of the dropped calls was 0.51. The highest call drop value was 1, the lowest 0. A system with nesting level of 4 uses a manifold network wireless system such as embodiments of the manifold network wireless communication system described herein.

The dropped call results for a system with nesting level of 4 that serves two hundred UEs is shown in FIG. 11H. The duration was 320 iterations. The average number of dropped calls within the time period was 1.6. The standard deviation of the dropped calls was 0.96. The highest call drop value was 3, the lowest 1. A system with nesting level of 4 uses a manifold network wireless system such as embodiments of the manifold network wireless communication system described herein.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A radio network controller configurable to be communicatively coupled to a plurality of base stations that provide wireless connectivity within a geographic area such that user equipment in the geographic area maintain a substantially continuous call connection with at least two of the plurality of base stations, wherein the radio network controller is configurable to select an active set of base stations from the plurality of base stations for the user equipment, and wherein the radio network controller is configurable to select a configurable number of the plurality of base stations from the active set to maintain the substantially continuous call connection with the user equipment, and wherein the configurable number is at least two.

2. The radio network controller of claim 1, wherein the radio network controller is configurable to associate bits in a connection code with the base stations in the active set and to modify the association of the bits with base stations in response to changes in the base stations in the active set.

3. The radio network controller of claim 2, wherein the values of the bits in the connection code indicate which of the base stations from the active set are selected to maintain the substantially continuous call connection with the user equipment.

4. The radio network controller of claim 1, wherein the radio network controller is configurable to select the active set of base stations based on at least one of a ratio of a chip energy to interference, a received signal strength indicator, or a transmit signal strength indicator and to modify membership of base stations in the active set for the user equipment in response to changes in at least one of the ratio of a chip energy to interference, the received signal strength indicator, or the transmit signal strength indicator.

5. The radio network controller of claim 4, wherein the radio network controller is configurable to select the configurable number of base stations based on at least one of the ratio of a chip energy to interference, the received signal strength indicator, or the transmit signal strength indicator and to modify values of the bits in the connection codes to indicate the selected configurable number of base stations.

6. The radio network controller of claim 1, wherein the plurality of base stations comprises at least one overlying base station that provides wireless connectivity to at least one coverage area that substantially encompasses at least one subset of the plurality of base stations, and wherein the radio network controller is configurable to select said at least one overlying base station and said at least one subset of the plurality of base stations for the active set associated with the user equipment.

7. The radio network controller of claim 6, wherein said at least one overlying base station has a lower priority than said at least one subset of the plurality of base stations, and wherein the radio network controller is configurable to preferentially select the configurable number of base stations from said at least one subset of base station in the active set to maintain the substantially continuous call connection with the user equipment.

8. The radio network controller of claim 7, wherein the radio network controller is configurable to select said at least one overlying base station for the active set when fewer than the configurable number of base stations from said at least one subset of base stations are available to maintain the substantially continuous call connection with the user equipment.

9. User equipment configurable to maintain substantially continuous call connections with a configurable number of base stations throughout a geographic area served by a plurality of base stations, wherein the configurable number of base stations is selected from an active set of base stations, and wherein the active set of base stations is selected from the plurality of base stations, and wherein the configurable number is at least two.

10. The user equipment of claim 9, wherein the base stations in the active set are each associated with a bit in a connection code stored by the user equipment, and wherein the values of the bits in the connection code indicate which of the base stations from the active set are selected to maintain the substantially continuous call connection with the user equipment.

11. The user equipment of claim 10, wherein a number of bits in the connection code corresponds to a maximum number of base stations that can be allocated to the active set.

12. The user equipment of claim 10, wherein the user equipment is configurable to associate the bits in the connection codes with different base stations in response to changes in the base stations in the active set.

13. The user equipment of claim 10, wherein the active set of base stations is selected based on at least one of a ratio of a chip energy to interference, a received signal strength indicator, or a transmit signal strength indicator.

14. The user equipment of claim 13, wherein the base stations in the active set are modified in response to changes in at least one of the ratio of the chip energy to interference, the received signal strength indicator, or the transmit signal strength indicator, and wherein the modifications to the active set are indicated by changing at least one bit in the connection code stored by the user equipment.

15. The user equipment of claim 13, wherein the configurable number of base stations is selected based on at least one of the ratio of a chip energy to interference, the received signal strength indicator, or the transmit signal strength indicator.

16. The user equipment of claim 15, wherein values of the bits in the connection codes stored by the user equipment are modifiable to indicate changes to the selected configurable number of base stations.

17. A base station configurable to be deployed as one of a plurality of base stations that provide wireless connectivity within a geographic area such that user equipment in the geographic area maintain a substantially continuous call connection with at least two of the plurality of base stations, wherein the base station is configurable to be communicatively coupled to a radio network controller that is communicatively coupled to the plurality of base stations, wherein the base station is configurable for selection to an active set of base stations from the plurality of base stations for the user equipment, and wherein the base station is configurable for selection to a configurable number of the plurality of base stations selected from the active set to maintain the substantially continuous call connection with the user equipment, and wherein the configurable number is at least two.

18. The base station of claim 17, wherein the base station is configurable to be added to the active set of base stations based on at least one of a ratio of a chip energy to interference, a received signal strength indicator, or a transmit signal strength indicator.

19. The base station of claim 18, wherein membership of the base station in the active set is modifiable in response to changes in at least one of the ratio of the chip energy to interference, the received signal strength indicator, or the transmit signal strength indicator.

20. The base station of claim 19, wherein the base station is configurable to establish or tear down a wireless communication link with the user equipment in response to modification in the base station's membership in the active set.

21. The base station of claim 20, wherein the base station is configurable to establish the wireless communication link with the user equipment in response to being selected to maintain the substantially continuous call connection with the user equipment.

22. The base station of claim 20, wherein the base station is configurable to tear down the wireless communication link with the user equipment in response to being removed from the set of base stations that maintain the substantially continuous call connection with the user equipment.

23. A wireless communication system, comprising:
a plurality of base stations configurable to provide wireless connectivity within a geographic area such that user equipment in the geographic area maintain a substantially continuous call connection with at least two of the plurality of base stations; and
at least one radio network controller that is communicatively coupled to the plurality of base stations, wherein the radio network controller is configurable to select an active set of base stations from the plurality of base stations for the user equipment, and wherein the radio network controller is configurable to select a configurable number of the plurality of base stations from the active set to maintain the substantially continuous call connection with the user equipment, and wherein the configurable number is at least two.

24. The wireless communication system of claim 23, wherein said at least one radio network controller is configurable to associate bits in a connection code with the base stations in the active set.

25. The wireless communication system of claim 24, wherein a number of bits in the connection code corresponds to a maximum number of base stations that can be allocated to the active set.

26. The wireless communication system of claim 24, wherein said at least one radio network controller is configurable to associate the bits in the connection codes with different base stations in response to changes in the base stations in the active set.

27. The wireless communication system of claim 24, wherein the values of the bits in the connection code indicate which of the base stations from the active set are selected to maintain the substantially continuous call connection with the user equipment.

28. The wireless communication system of claim 24, wherein said at least one radio network controller is configurable to select the active set of base stations based on at least one of a ratio of a chip energy to interference, a received signal strength indicator, or a transmit signal strength indicator.

29. The wireless communication system of claim 28, wherein said at least one radio network controller is configurable to modify membership of base stations in the active set for the user equipment in response to changes in at least one of the ratio of the chip energy to interference, the received signal strength indicator, or the transmit signal strength indicator.

30. The wireless communication system of claim 28, wherein said at least one radio network controller is configurable to select the configurable number of base stations based on at least one of the ratio of the chip energy to interference, the received signal strength indicator, or the transmit signal strength indicator.

31. The wireless communication system of claim 30, wherein said at least one radio network controller is configurable to modify values of the bits in the connection codes to indicate the selected configurable number of base stations.

32. The wireless communication system of claim 23, wherein the plurality of base stations comprises at least one overlying base station that provides wireless connectivity to at least one coverage area that substantially encompasses at least one subset of the plurality of base stations.

33. The wireless communication system of claim 32, wherein the radio network controller is configurable to select said at least one overlying base station and said at least one subset of the plurality of base stations for the active set associated with the user equipment.

34. The wireless communication system of claim 33, wherein said at least one overlying base station has a lower priority than said at least one subset of the plurality of base stations, and wherein the radio network controller is configurable to preferentially select the configurable number of base stations from said at least one subset of base station in the active set to maintain the substantially continuous call connection with the user equipment.

35. The wireless communication system of claim 34, wherein the radio network controller is configurable to select said at least one overlying base station for the active set when less than the configurable number of base stations from said at least one subset of base stations are available to maintain the substantially continuous call connection with the user equipment.

36. A method, comprising:
establishing, at user equipment, substantially continuous call connections with a configurable number of base stations when the user equipment is within a geographical area served by a plurality of base stations, wherein the configurable number of base stations is selected from an active set of base stations, and wherein the active set of base stations is selected from the plurality of base stations, and wherein the configurable number is at least two, and wherein the base stations in the active set are each associated with a bit in a connection code stored by the user equipment.

37. The method of claim 36, wherein establishing the substantially continuous call connection comprises establishing the substantially continuous call connection based on the values of the bits in the connection code that indicate which of the base stations from the active set are selected to maintain the substantially continuous call connection with the user equipment.

38. The method of claim 37, comprising associating the bits in the connection codes with different base stations in response to changes in the base stations in the active set.

39. The method of claim 38, wherein associating the bits in the connection codes with different base stations comprises associating the bits in the connection codes with different base stations in response to receiving a mapping of the connection codes to the base stations, wherein the mapping is generated by a radio network controller.

40. The method of claim 39, wherein associating the bits in the connection codes with different base stations comprises associating the bits in the connection codes with different base stations in response to the base stations in the active set being modified in response to changes in at least one of a ratio of the chip energy to interference, a received signal strength indicator, or a transmit signal strength indicator, and wherein the modifications to the active set are indicated by changing at least one bit in the connection code stored by the user equipment.

41. The method of claim 40, wherein the configurable number of base stations is selected based on at least one of the ratio of a chip energy to interference, the received signal strength indicator, or the transmit signal strength indicator.

42. The method of claim 41, comprising modifying values of the bits in the connection codes stored by the user equipment to indicate changes to the selected configurable number of base stations.

43. A method, comprising:
establishing, at a first base station, a first wireless communication link with user equipment concurrently with at least one second wireless communication link established by at least one second base station so that the user equipment maintains substantially continuous call connections with a configurable number of base stations when the user equipment is within a geographical area served by a plurality of base stations, wherein the configurable number of base stations comprising the first base station is selected from an active set of base stations, and wherein the active set of base stations comprising the first base station is selected from the plurality of base stations, and wherein the configurable number is at least two.

44. The method of claim 43, comprising modifying membership of the first base station in the active set in response to changes in at least one of a ratio of a chip energy to interference, a received signal strength indicator, or a transmit signal strength indicator.

45. The method of claim 44, comprising establishing or tearing down the first wireless communication link with the user equipment in response to modification of the first base station's membership in the active set.

46. The method of claim 45, comprising establishing the first wireless communication link with the user equipment in response to the first base station being selected to maintain the substantially continuous call connection with the user equipment.

47. The method of claim 45, comprising tearing down the first wireless communication link with the user equipment in response to the first base station being removed from the set of base stations that maintain the substantially continuous call connection with the user equipment.
